(19) United States
(12) Patent Application Publication
(10) Pub. No.: US 2010/0220234 A1
(43) Pub. Date: Sep. 2, 2010

(54) IMAGE/SOUND SUPPLY APPARATUS, IMAGE/SOUND SUPPLY METHOD, AND COMPUTER PROGRAM PRODUCT

(75) Inventors: Issei Yokoyama, Matsumoto-shi (JP); Tomohiro Nomizo, Shiojiri-shi (JP)

Correspondence Address: ADVANTEDGE LAW GROUP, LLC, 922 W. BAXTER DRIVE, SUITE 100, SOUTH JORDAN, UT, 84095, US

(73) Assignee: Seiko Epson Corporation, Tokyo (JP)

(21) Appl. No.: 12/712,364

(22) Filed: Feb. 25, 2010

(30) Foreign Application Priority Data
Feb. 27, 2009 (JP) 2009-045776

(51) Int. Cl. H04N 7/045

(52) U.S. Cl. 348/552; 348/744; 348/E07.041; 348/738

(57) ABSTRACT

An image/sound output method in an image/sound supply apparatus connected to an image/sound output apparatus includes: receiving residual-quantity data indicating the residual quantity of a data buffer memory provided in the image/sound output apparatus from the image/sound output apparatus; storing a lower and upper limit value of the proportion of sound data to be transmitted to the residual quantity of the data buffer memory; calculating the proportion of the sound data to be transmitted to the residual quantity of the data buffer memory in the image/sound output apparatus and comparing the calculated proportion and a lower or upper limit value and selects a sampling frequency for the sound data in accordance with the comparison result; converting the sound data to be transmitted with the sampling frequency selected by the frequency selecting section; and transmitting the converted sound data to the image/sound output apparatus.

### CROSS-REFERENCE

The present application claims priority from Japanese Patent Application No. 2009-045776 filed on Feb. 27, 2009, which is hereby incorporated by reference in its entirety.

### BACKGROUND

In recent years, projectors have been widely spread. Increasingly, a computer, for example, is connected to a projector, and supplies image data (of a moving picture or a still picture) and sound data to the projector. The projector reads the data and displays the image and reproduces the sound.

In this case, in general, the data is transferred preferably at a constant rate from an apparatus (such as a computer) that supplies image data and sound data to an apparatus (such as a projector) that outputs the image data and sound data. However, some apparatus and/or network environments do not guarantee a stable data transfer rate. In order to solve the problem, a projector may include a data buffer memory that temporarily stores data, and the projector may read and reproduce the data transmitted from the computer and stored in the buffer. As a result, the image and sound can be output in a stable manner.

Breaks of the sound output particularly have a great perceptual influence on a viewer. Therefore, reproducing sound securely is important. However, even a projector including a buffer may stop the sound output when the data transfer rate of a transmission path decreases, which may delay the data transfer, cause a data shortage in the buffer and result in no sound to reproduce.

Japanese Patent Publication No. 2005-257750 (Patent Document 1 hereinafter) discloses a technology that, if the reproducing frequencies and/or reproducing speeds differ between the transmitter side and the receiver side in sound communication equipment, starts sound output when the accumulated amount of data in a buffer of the receiver side is larger than a preset initial amount of delay so as to prevent breaks.

However, according to Patent Document 1, sound is output after the data is accumulated in a buffer to some extent, which lacks the real time characteristic. It may not be suitable to cases where reproducing sound in proper timing to corresponding images is required, for example, like the reproduction by projectors.

Since the sound communication equipment in Patent Document 1 discards data when a larger amount of data is accumulated in the buffer, it causes a dropout and discontinuous sound and may give a viewer a sense of discomfort.

### SUMMARY

Various embodiments may provide an image/sound supply apparatus, image/sound output apparatus, image supply method, image/sound output method, and program by which the sound data transmitted from the image/sound supply apparatus, which transmits image and sound data, are reproduced by the image/sound output apparatus, which outputs the transmitted image and sound data, with continuity and without stopping sound output.

According to at least one embodiment of the disclosure, there is provided an image/sound supply apparatus connected to an image/sound output apparatus that outputs sound data and image data. The image/sound supply apparatus includes a residual-buffer-quantity-data receiving section that receives residual-quantity data indicating the residual quantity of a data buffer memory provided in the image/sound output apparatus from the image/sound output apparatus, a frequency selecting section that calculates the proportion of the sound data to be transmitted to the residual quantity of the data buffer memory in the image/sound output apparatus on the basis of the residual-quantity data received by the residual-buffer-quantity-data receiving section and compares the calculated proportion and a lower limit value or an upper limit value of the proportion of sound data to be transmitted to the residual quantity of the data buffer memory and selects a sampling frequency for the sound data in accordance with the comparison result, a data converting section that converts the sound data to be transmitted with the sampling frequency selected by the frequency selecting section, and a data transmitting section that transmits the converted sound data to the image/sound output apparatus.

The frequency selecting section may reduce the sampling frequency if the residual-quantity data of the data buffer memory in the image/sound supply apparatus is smaller than the lower limit value and increase the sampling frequency if the residual-quantity data of the data buffer memory in the image/sound supply apparatus is larger than the upper limit value.

The image/sound supply apparatus may further include a criterion changing section that changes the lower limit value to a second lower limit value that is a value smaller than the lower limit value if the sampling frequency is reduced and changes the upper limit value to a second upper limit value that is a value larger than the upper limit value if the sampling frequency is increased.

According to at least one embodiment of the disclosure, there is provided an image/sound output apparatus that outputs image data and sound data transmitted from an image/sound supply apparatus. The image/sound output apparatus includes a data buffer memory that stores sound data transmitted from the image/sound supply apparatus, a storage unit that stores a lower limit value and an upper limit value of the proportion of sound data to the residual quantity of the data buffer memory, a section that detects the residual quantity of the data buffer memory, a frequency selecting section that compares the proportion of the sound data stored in the data buffer memory to the residual quantity of the data buffer memory and the lower limit value or upper limit value stored in the storage unit and selects the sampling frequency for the sound data in accordance with the comparison result, a data converting section that converts the sound data with the selected sampling frequency, and a sound output unit that outputs sound on the basis of the converted sound data.

According to at least one embodiment of the disclosure, there is provided an image/sound supply method in an image/sound supply apparatus connected to an image/sound output apparatus that outputs sound data and image data. The method includes receiving residual-quantity data indicating the residual quantity of a data buffer memory provided in the image/sound output apparatus from the image/sound output apparatus, by a residual-buffer-quantity-data receiving section, calculating the proportion of the sound data to be transmitted to the residual quantity of the data buffer memory in the image/sound output apparatus on the basis of the residual-quantity data received by the residual-buffer-quantity-data receiving section and comparing the calculated proportion and a lower limit value or an upper limit value of the proportion of sound data to be transmitted to the residual quantity of the data buffer memory and selecting a sampling frequency for the sound data in accordance with the comparison result, by a frequency selecting section, converting the sound data to be transmitted with the sampling frequency selected by the frequency selecting section, by a data converting section, and transmitting the converted sound data to the image/sound output apparatus, by a data transmitting section.

According to at least one embodiment of the disclosure, there is provided a program causing a computer connected to an image/sound output apparatus that outputs sound data and image data to function as a residual-buffer-quantity-data receiving section that receives residual-quantity data indicating the residual quantity of a data buffer memory provided in the image/sound output apparatus from the image/sound output apparatus, a frequency selecting section that calculates the proportion of the sound data to be transmitted to the residual quantity of the data buffer memory in the image/sound output apparatus on the basis of the residual-quantity data received by the residual-buffer-quantity-data receiving section and compares the calculated proportion and a lower limit value or an upper limit value of the proportion of sound data to be transmitted to the residual quantity of the data buffer memory and selects a sampling frequency for the sound data in accordance with the comparison result, a data converting section that converts the sound data to be transmitted with the sampling frequency selected by the frequency selecting section, and a data transmitting section that transmits the converted sound data to the image/sound output apparatus.

According to at least one embodiment of the disclosure, there is provided an image/sound output method in an image/sound output apparatus that outputs image data and sound data transmitted from an image/sound supply apparatus. The method includes detecting the residual quantity of a data buffer memory that stores sound data transmitted from the image/sound supply apparatus, by a detecting unit, comparing the proportion of the sound data stored in the data buffer memory to the residual quantity of the data buffer memory and the lower limit value or upper limit value stored in a storage unit that stores a lower limit value and an upper limit value of the proportion of sound data to the residual quantity of the data buffer memory and selecting the sampling frequency for the sound data in accordance with the comparison result, by a frequency selecting section, converting the sound data with the selected sampling frequency, by a data converting section, and outputting sound on the basis of the converted sound data, by a sound output unit.

According to at least one embodiment of the disclosure, there is provided a program causing a computer that controls an image/sound output apparatus that outputs image data and sound data transmitted from an image/sound supply apparatus so as to function as a section that detects the residual quantity of a data buffer memory that stores sound data transmitted from the image/sound supply apparatus, a frequency selecting section that compares the proportion of sound data stored in the data buffer memory to the residual quantity of the data buffer memory and the lower limit value or upper limit value stored in a storage unit that stores a smaller limit value and an upper limit value of the proportion of sound data to the residual quantity of the data buffer memory and selects a sampling frequency for the sound data in accordance with the comparison result, a data converting section that converts the sound data with the selected sampling frequency, and a sound output unit that outputs sound on the basis of the converted sound data.

Here, the image/sound supply apparatus may be a computer apparatus, for example, and has a function of transmitting image data and sound data to an external apparatus, which is the image/sound output apparatus here, connected to the image/sound supply apparatus. The image/sound output apparatus may be a projector having a function of outputting an image and sound, for example. The image/sound supply apparatus checks the residual quantity of the data buffer memory for sound in the image/sound output apparatus, converts the amount of sound data in accordance with the residual quantity and then transmits the sound data. Thus the image/sound output apparatus can reproduce sound without problems such as breaks and dropouts.

According to above embodiments, the image/sound output apparatus can reproduce the sound data transmitted from the image/sound supply apparatus with continuity of sound and without changing the amount of sound data to be stored in image/sound supply apparatus and without breaks.

### BRIEF DESCRIPTION OF THE DRAWINGS

Non-limiting and non-exhaustive embodiments of the present disclosure will be described with reference to the accompanying drawings, wherein like reference numbers reference like elements.

FIG. 1 is a functional block diagram of an image reproducing system.

FIG. 2 is a functional block diagram of an image/sound supply apparatus.

FIG. 3 is a flowchart illustrating a flow of sound data supply/reproduction processing.

FIG. 4 is a functional block diagram of an image/sound supply apparatus according to second embodiment.

FIG. 5 is a flowchart illustrating a flow of sound data supply/reproduction processing.

FIG. 6 is a flowchart illustrating a flow of sound data supply/reproduction processing.

### DESCRIPTION OF EMBODIMENTS

With reference to attached drawings, preferred embodiments of the image/sound supply apparatus and image/sound output apparatus according to the invention will be described in detail below. In the following descriptions and attached drawings, like numbers reference components having substantially like functions, and the repetitive descriptions and illustrations will be omitted.

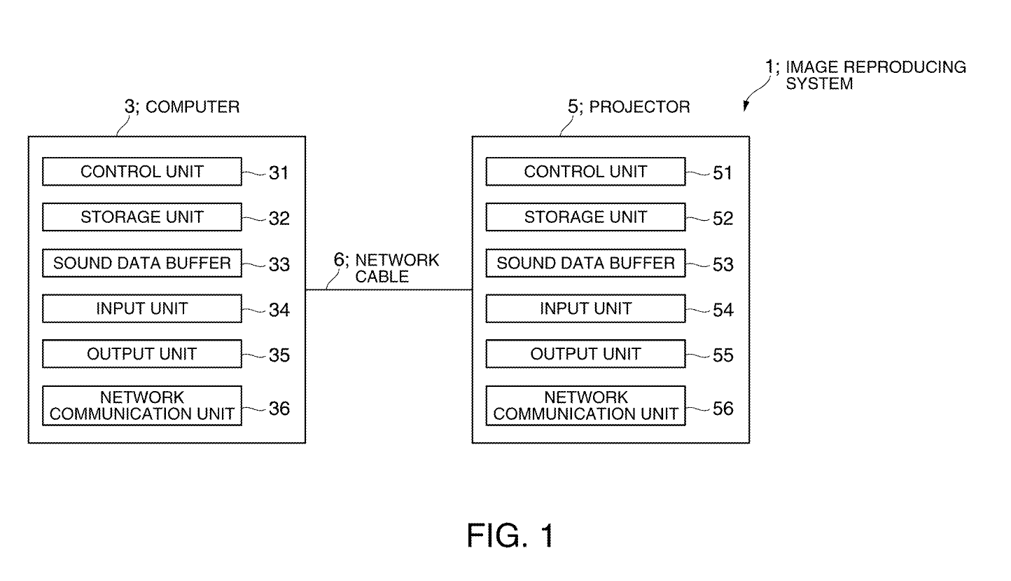

FIG. 1 is a functional block diagram of an image reproducing system. The image reproducing system 1 includes a computer 3 that is an image/sound supply apparatus and a projector 5 that is an image/sound output apparatus. The computer 3 and projector 5 are connected via a network cable 6 such that they can exchange data. The network cable 6 may be a LAN cable or a USB cable, for example.

The computer 3 stores image data and sound data and may reproduce them by itself. The computer 3 transmits image data and sound data to the projector 5 via the network cable 6, and the projector 5 outputs the image and the sound on the basis of the transmitted data. The transmission and reproduction of sound data will be described below.

The computer 3 has a control unit 31, a storage unit 32, a sound data buffer 33, an input unit 34, an output unit 35, and a network communication unit 36. The control unit 31 may be a central processing unit (or CPU) or a microprocessor, for example, and controls the components of the computer 3 and performs processing, which will be described later. The storage unit 32 is a storage device such as a non-volatile memory, a volatile memory and a hard disk and stores sound data to be transmitted and data required for processing, which will be described later. The sound data buffer 33 is a data buffer memory that stores sound data to be transmitted. The input unit 34 is an input device such as a keyboard and a mouse. The output unit 35 is a sound output apparatus such as a display and a speaker. The network communication unit 36 exchanges data with the projector 5 via the network cable 6.

The projector 5 has a control unit 51, a storage unit 52, a sound data buffer 53, an input unit 34, an output unit 55, and a network communication unit 56. The control unit 51 may be a central processing unit or a microprocessor, for example, and controls other components and performs processing, which will be described later. The storage unit 52 is a storage device such as a non-volatile memory, a volatile memory, and a hard disk. The sound data buffer 53 is a data buffer memory that stores sound data transmitted from the computer 3. The input unit 34 is an input device such as a control button for controlling the projector 5. The output unit 35 is a sound output apparatus such as a projector and a speaker. The network communication unit 36 is an apparatus that exchanges data with the computer 3 via the network cable 6.

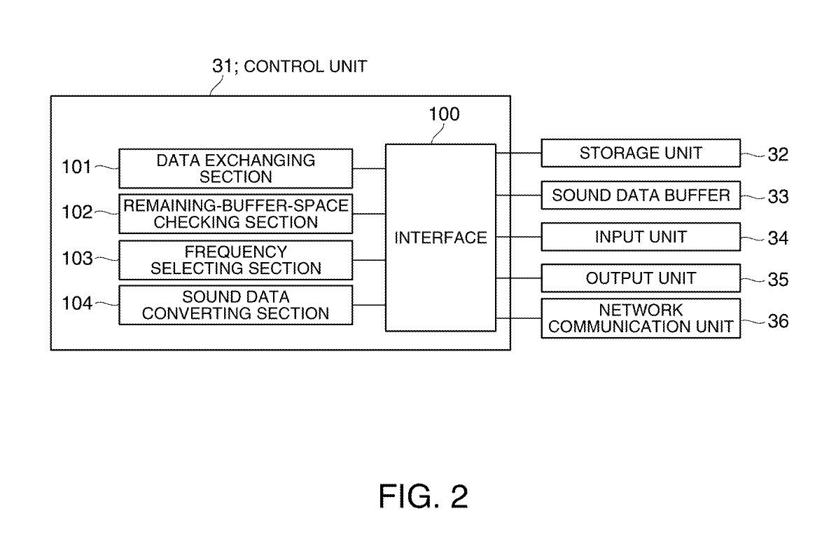

FIG. 2 is a functional block configuration diagram of the control unit 31 in the computer 3.

The control unit 31 has an interface 100, a data exchanging section 101, a residual-buffer-quantity checking section 102, a frequency selecting section 103, and a sound data converting section 104.

The storage unit 32, sound data buffer 33, input unit 34, output unit 35, and network communication unit 36 in the computer 3 are connected to the data exchanging section 101, residual-buffer-quantity checking section 102, frequency selecting section 103, sound data converting section 104, which are processing function units, through the interface 100 to perform processing. The processing operations by the units will be described in detail below.

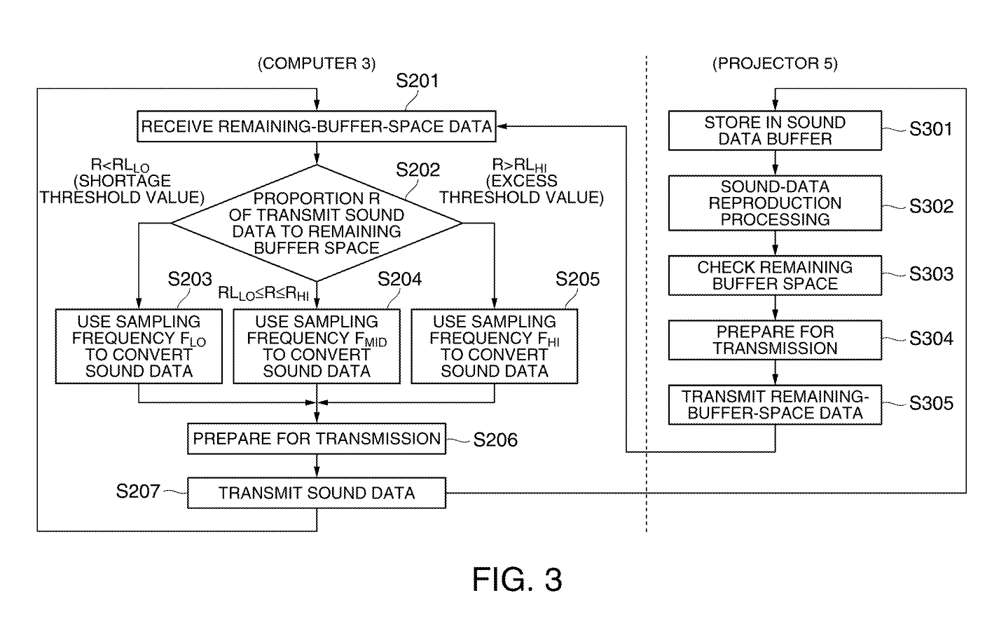

FIG. 3 is a flowchart of sound data supply/reproduction processing.

The case will be described where the computer 3 is connected to the projector 5 via the network cable 6, and a moving picture stored in the storage unit 32 in the computer 3 is reproduced and the data for reproducing the moving picture is supplied to the projector 5.

The processing illustrated in FIG. 3 includes processing operations by the computer 3 and projector 5. The computer 3 transmits transmit sound data stored in the sound data buffer 33 to the projector 5, and the projector 5 stores the received transmit sound data to the sound data buffer 53 and reproduces it. By repeating this, the projector 5 outputs the image and reproduces the sound.

The data exchanging section 101 in the control unit 31 in the computer 3 receives residual-quantity data indicating the residual quantity of the sound data buffer 53 from the projector 5 (step S201). The residual-buffer-quantity checking section 102 obtains the residual quantity of the sound data buffer 53 on the basis of the received residual-quantity data. The frequency selecting section 103 calculates a proportion R of the amount of transmit sound data to the calculated residual quantity of the sound data buffer 53 and compares the calculated proportion R and a shortage threshold value RL_{LO} and excess threshold value RL_{HI} stored in the storage unit 32 (step S202).

Here, the shortage threshold value RL_{LO} is a smaller limit value of the range of the proportion of the amount of data in the sound data buffer 53 with which the projector 5 can output sound without breaks. If the proportion of the amount of sound data to the buffer quantity is smaller than the lower limit value, the data to reproduce is lacking, and the sound breaks. The excess threshold value RL_{HI} is an upper limit value of the range of the proportion of the amount of data in the sound data buffer 53 with which the projector 5 can output sound without breaks. If the proportion of the amount of sound data to the buffer quantity is larger than the upper limit value, the data to reproduce is excessive, causing a skipping of sound data (or dropout) and no longer keeping the continuity of the sound content. Conversely, the amount of sound data to the sound data buffer 53 is within the range from the lower limit value to the upper limit value, the projector 5 can reproduce the sound without breaks and without dropouts.

In step S202, if the proportion R of the amount of transmit sound data to the residual quantity of the sound data buffer 53 is smaller than the shortage threshold value RL_{LO}, that is R<RL_{LO}, the frequency selecting section 103 selects a sampling frequency F_{LO}. The sound data converting section 104 uses the sampling frequency F_{LO} to convert the transmit sound data (step S203). Here, the sampling frequency F_{LO} is lower than a normal sampling frequency F_{MID}, and using the sampling frequency F_{LO} to convert sound data extends the sound data in time.

The shortage threshold value RL_{LO} and sampling frequencies F_{MID} and F_{LO} are predetermined and may be stored in the storage unit 32.

In step S202, if the proportion R of the amount of transmit sound data to the residual quantity of the sound data buffer 53 is larger than the excess threshold value RL_{HI}, that is RL_{HI}<R, the frequency selecting section 103 selects a sampling frequency F_{HI}. The sound data converting section 104 uses the sampling frequency F_{HI} to convert the transmit sound data (step S205). Here, the sampling frequency F_{HI} is higher than the normal sampling frequency F_{MID}, and using the sampling frequency F_{HI} to convert the sound data shortens the sound data in time.

The excess threshold value RL_{HI} and sampling frequency F_{HI} are predetermined and may be stored in the storage unit 32.

In step S202, if the proportion R of the amount of transmit sound data to the residual quantity of the sound data buffer 53 is within the range between the shortage threshold value RL_{LO} being the lower limit value and the excess threshold value RL_{HI} being the upper limit value (RL_{LO}≦R≦RL_{HI}), the frequency selecting section 103 selects the normal sampling frequency F_{MID}. The sound data converting section 104 uses the sampling frequency F_{MID} to convert the transmit sound data (step S204).

For example, when the shortage threshold value RL_{LO} is 60% and the excess threshold value RL_{HI} is 100% and if the proportion R of the amount of transmit sound data to the residual quantity of the sound data buffer 53 is 40%, the sound data converting section 104 uses the sampling frequency F_{LO} to convert the transmit sound data. If the proportion R of the amount of transmit sound data to the residual quantity of the sound data buffer 53 is 80%, the sound data converting section 104 uses the sampling frequency F_{MID} to convert the transmit sound data. If the proportion R of the amount of transmit sound data to the residual quantity of the sound data buffer 53 is 110%, the sound data converting section 104 uses the sampling frequency F_{HI} to convert the transmit sound data.

The sound data converting section 104 stores the converted transmit sound data to the sound data buffer 33 for preparation for the transmission (step S206). The data exchanging section 101 transmits the transmit sound data to the projector 5 (step S207).

The projector 5 stores the transmitted transmit sound data to the sound data buffer 53 (step S301) and performs reproduction processing on the sound data (step S302). The projector 5 next checks the residual quantity of the sound data buffer 53 (step S303), creates the residual-buffer-quantity data for preparation for the transmission (step S304), and transmits the residual-buffer-quantity data to the computer 3 (step S305). Then, the projector 5 moves to step S201 and repeats the processing from step S201 to step S305 until the sound data to be reproduced are entirely reproduced.

According to this embodiment, before transmitting sound data, the computer 3 checks the residual quantity of the sound data buffer 53 in the projector 5 being the image/sound output apparatus, selects the sampling frequency according to the residual quantity and converts and transmits the sound data with it. Thus, the projector 5 can reproduce the sound without breaks and/or dropouts, which allows the simultaneous reproduction of the sound data in real time with the reproduction of the image data.

Since the sound data on the original computer 3 do not change, the computer 3 may read and reproduce the sound data as it is.

According to this embodiment, proportions are used such as the upper limit value and lower limit value of the proportion of the amount of data in the sound data buffer 53 and the proportion of transmit sound data to the residual quantity of the sound data buffer 53, which allow the projector 5 to output without sound breaks. However, instead of the proportions, the amount of data may also be used to perform similar processing and provide similar effects.

According to this embodiment, the computer 3 performs the processing by the residual-buffer-quantity checking section 102, frequency selecting section 103, and sound data converting section 104 illustrated in FIG. 2. However, the functions may be performed by the projector 5. In other words, the projector 5 may receive sound data from the computer 3, check the residual quantity of its sound data buffer 53, perform the aforementioned processing, convert and reproduce the sound data so as to fit to the residual quantity.

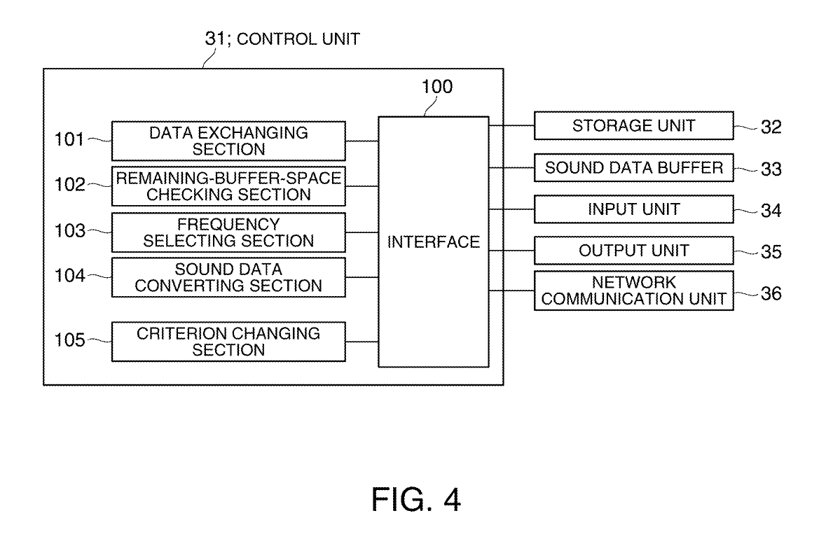

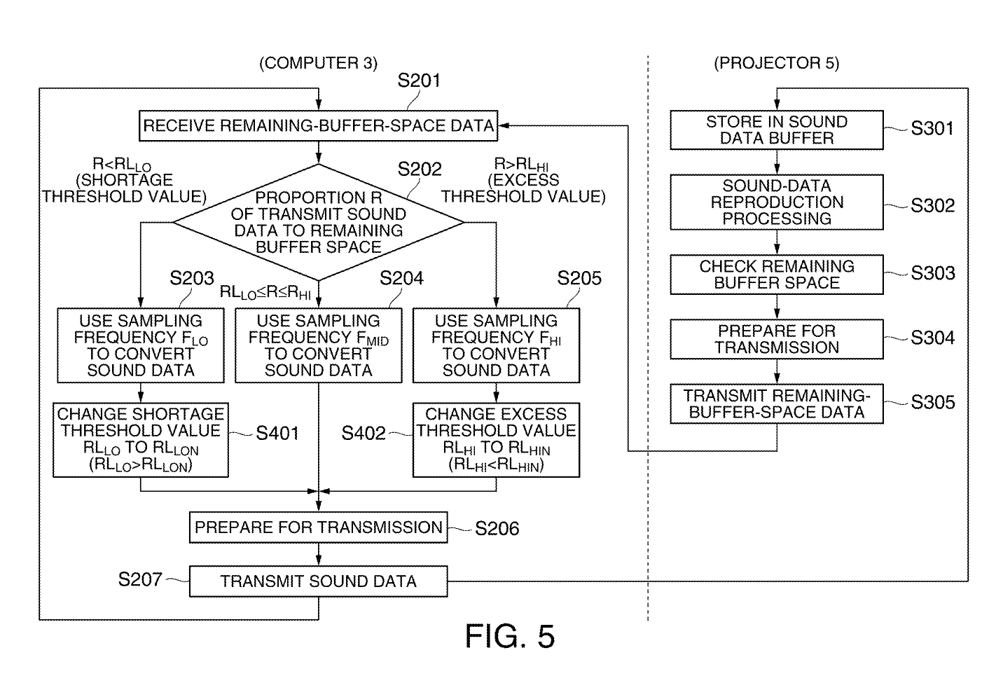

Next, a second embodiment will be described. FIG. 4 is a functional block diagram of a control unit 31 in a computer 3 according to the second embodiment. FIG. 5 is a flowchart of sound data supply/reproduction processing according to the second embodiment.

FIG. 4 is substantially similar to the configuration diagram illustrated in FIG. 2 but is different in that a criterion changing section 105 is provided therein.

The flowchart illustrated in FIG. 5 is substantially similar to the flowchart illustrated in FIG. 3 but is different in that step S401 and step S402 are added thereto.

In step S202, if the proportion R of the amount of transmit sound data to the residual quantity of the sound data buffer 53 is smaller than the shortage threshold value RL_{LO}, that is R<RL_{LO}, the sound data converting section 104 uses the sampling frequency F_{LO} to convert the transmit sound data (step S203). The criterion changing section 105 changes the shortage threshold value RL_{LO} to a shortage threshold value RL_{LON} (step S401).

In step S202, if the proportion R of the amount of transmit sound data to the residual quantity of the sound data buffer 53 is larger than the excess threshold value RL_{HI}, that is RL_{HI}<R, the sound data converting section 104 uses the sampling frequency F_{HI} to convert the transmit sound data (step S205). The criterion changing section 105 changes the excess threshold value RL_{HI} to an excess threshold value RL_{HIN} (step S402).

In this way, when the sampling frequency is changed, the criterion changing section 105 determines that there is the tendency and changes the shortage threshold value RL_{LO} being the lower limit value and the excess threshold value RL_{HI} being the upper limit value, which are the criteria. The shortage threshold value RL_{LON} and excess threshold value RL_{HIN} may be predetermined and be stored in the storage unit 32. Alternatively, the increment or decrement from the shortage threshold value RL_{LO} and excess threshold value RL_{HI} may be stored in the storage unit 32, and the shortage threshold value RL_{LON} and excess threshold value RL_{HIN} may be calculated from them.

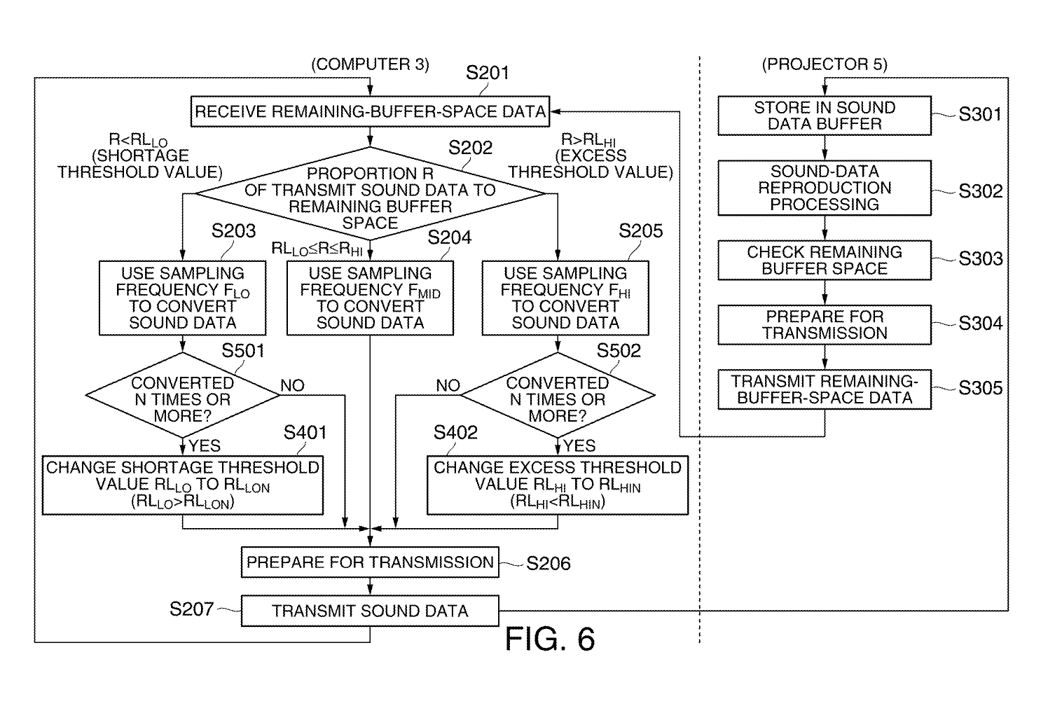

Next, a third embodiment of the invention will be described. FIG. 6 is a flowchart of sound data supply/reproduction processing according to the third embodiment. The flowchart illustrated in FIG. 6 is substantially similar to the flowchart illustrated in FIG. 5 but is different in that step S501 and step S502 are added.

In step S202, if the proportion R of the amount of transmit sound data to the residual quantity of the sound data buffer 53 is smaller than the shortage threshold value RL_{LO}, that is R<RL_{LO}, the sound data converting section 104 uses the sampling frequency F_{LO} to convert the transmit sound data (step S203). In step S501, the criterion changing section 105 determines whether step S203 is repeated N times or more, and if so (YES in step S501), the shortage threshold value RL_{LO} is reduced to a shortage threshold value RL_{LON} (step S401). If it is not determined in step S501 that step S203 is repeated N times or more (NO in step S501), the shortage threshold value is not changed.

In step S202, if the proportion R of the amount of transmit sound data to the residual quantity of the sound data buffer 53 is larger than the excess threshold value RL_{HI}, that is RL_{HI}<R, the sound data converting section 104 uses the sampling frequency F_{HI} to convert the transmit sound data (step S205). In step S502, the criterion changing section 105 determines whether step S205 is repeated N times or more, and if so (YES in step S502), the criterion changing section 105 changes the excess threshold value RL_{HI} to an excess threshold value RL_{HIN} (step S402). In step S502, if it is not determined that step S205 is repeated N times or more (NO in step S502), the excess threshold value is not changed.

In this way, when the sampling frequency is changed N times in series, the criterion changing section 105 determines that there is the tendency and changes the shortage threshold value RL_{LO} being the lower limit value and the excess threshold value RL_{HI} being the upper limit value, which are the criteria. The threshold value N may be determined properly and may be prestored in the storage unit 32.

A program implementing the aforementioned sound data transmission/reproduction processing by the control unit 31 in the computer 3 may be created, and a generic computer may read the program to implement the image/sound supply apparatus. The program may be recorded in a recording medium such as a CD-ROM or may be distributed over a network.

Having described the preferred embodiments of the image/sound supply apparatus, image/sound output apparatus, sound reproduction method, and program according to the invention with reference to the attached drawings, the invention is not limited to those examples. It is understood by those skilled in the art that alteration examples or modification examples can be reached without departing from the scope of the technical spirit disclosed herein and can naturally belong to the technical scope of the invention.

The image/sound output apparatus can reproduce the sound data transmitted from the image/sound supply apparatus without changing the amount of sound data stored in the image/sound supply apparatus, without breaks and with continuity of the content, and a viewer can enjoy the sound simultaneously and in real time with the corresponding image, without a sense of discomfort. The image/sound supply apparatus may be a computer, and the image/sound output apparatus may be a projector. Alternatively, the projector itself may convert and reproduce sound data properly in accordance with the residual quantity of a buffer therefor.

What is claimed is:

1. An image/sound supply apparatus connected to an image/sound output apparatus that outputs sound data and image data, the image/sound supply apparatus comprising:
a residual-buffer-quantity-data receiving section that receives residual-quantity data indicating the residual quantity of a data buffer memory provided in the image/sound output apparatus from the image/sound output apparatus;
a frequency selecting section that calculates the proportion of the sound data to be transmitted to the residual quantity of the data buffer memory in the image/sound output apparatus on the basis of the residual-quantity data received by the residual-buffer-quantity-data receiving section and compares the calculated proportion and a lower limit value or an upper limit value of the proportion of sound data to be transmitted to the residual quantity of the data buffer memory and selects a sampling frequency for the sound data in accordance with the comparison result;
a data converting section that converts the sound data to be transmitted with the sampling frequency selected by the frequency selecting section; and
a data transmitting section that transmits the converted sound data to the image/sound output apparatus.

2. The image/sound supply apparatus according to claim 1, the apparatus further comprising:
a storage unit that stores the lower limit value and the upper limit value of the proportion of sound data to be transmitted to the residual quantity of the data buffer memory.

3. The image/sound supply apparatus according to claim 1, wherein the frequency selecting section:
reduces the sampling frequency if the residual-quantity data of the data buffer memory in the image/sound supply apparatus is smaller than the lower limit value; and
increases the sampling frequency if the residual-quantity data of the data buffer memory in the image/sound supply apparatus is larger than the upper limit value.

4. The image/sound supply apparatus according to claim 2, the apparatus further comprising:
a criterion changing section that changes the lower limit value to a second lower limit value that is a value smaller than the lower limit value if the sampling frequency is reduced and changes the upper limit value to a second upper limit value that is a value larger than the upper limit value if the sampling frequency is increased.

5. The image/sound supply apparatus according to claim 2, the apparatus further comprising:
a criterion changing section that changes the lower limit value to a second lower limit value that is a value smaller than the lower limit value if the sampling frequency is reduced at predetermined times or more, and changes the upper limit value to a second upper limit value that is a value larger than the upper limit value if the sampling frequency is increased predetermined times or more.

6. An image/sound supply method in an image/sound supply apparatus connected to an image/sound output apparatus that outputs sound data and image data, the method comprising the steps of:
(a) receiving residual-quantity data indicating the residual quantity of a data buffer memory provided in the image/sound output apparatus from the image/sound output apparatus;
(b) calculating the proportion of the sound data to be transmitted to the residual quantity of the data buffer memory in the image/sound output apparatus on the basis of the residual-quantity data received by step (a);
(c) comparing the calculated proportion and a lower limit value or an upper limit value of the proportion of sound data to be transmitted to the residual quantity of the data buffer memory;
(d) selecting a sampling frequency for the sound data in accordance with the comparison result by step (c);
(e) converting the sound data to be transmitted with the sampling frequency selected by step (d); and
(f) transmitting the converted sound data to the image/sound output apparatus.

7. A computer program product embodied in at least one computer readable medium and comprising instructions executable by a computer connected to an image/sound output apparatus that outputs sound data and image data, the computer program product being adapted for causing the computer to perform the functions of:
(a) receiving residual-quantity data indicating the residual quantity of a data buffer memory provided in the image/sound output apparatus from the image/sound output apparatus;
(b) calculating the proportion of the sound data to be transmitted to the residual quantity of the data buffer memory in the image/sound output apparatus on the basis of the residual-quantity data received by step (a);
(c) comparing the calculated proportion and a lower limit value or an upper limit value of the proportion of sound data to be transmitted to the residual quantity of the data buffer memory;
(d) selecting a sampling frequency for the sound data in accordance with the comparison result;
(e) converting the sound data to be transmitted with the sampling frequency selected by step (d); and
(f) transmitting the converted sound data to the image/sound output apparatus.
